(19) United States
(12) Patent Application Publication
(10) Pub. No.: US 2026/0371153 A1
(43) Pub. Date: Nov. 19, 2026

(54) RECOVERY FROM QUALITY OF SERVICE (QoS) FLOW SET-UP FAILURE IN A MOBILE NETWORK

(71) Applicant: Verizon Patent and Licensing Inc., Basking Ridge, NJ (US)

(72) Inventors: Sudhakar Reddy Patil, Flower Mound, TX (US); Violeta Cakulev, Millburn, NJ (US); Jerry Steben, Fort Worth, TX (US); Lixia Yan, Basking Ridge, NJ (US); Raquel Morera Sempere, Weehawken, NJ (US)

(21) Appl. No.: 19/210,187

(22) Filed: May 16, 2025

(51) Int. Cl. H04W 28/02; H04L 65/1069

(52) U.S. Cl. CPC H04W 28/0268; H04L 65/1069

(57) ABSTRACT

A Session Management Function (SMF) determines a first Quality of Service (QoS) flow for a User Equipment (UE) session based on one or more first policy rules obtained from a Policy Control Function (PCF). The SMF engages with a Radio Access Network (RAN) in a first session resource set-up process for the first QoS flow for the UE session that results in session resource set-up failure. The SMF determines, in response to the session resource set-up failure, a second QoS flow to be requested for the UE session based on one or more second policy rules obtained from the PCF. The SMF engages with the RAN in a second session resource set-up process for the second QoS flow for the UE session, and receives, from the RAN, a session resource set-up success message indicating RAN resources for the second QoS flow for the UE session have been set up.

### BACKGROUND

Next Generation mobile networks, such as Fifth Generation New Radio (5G NR) mobile networks, may operate in various frequency ranges, including higher frequency ranges (e.g., in the gigahertz (GHz) frequency band), and may have a broad bandwidth (e.g., near 500-1,000 megahertz (MHz)). The bandwidth of Next Generation mobile networks supports higher speed downloads. The 5G mobile telecommunications standard supports more reliable, massive machine communications (e.g., machine-to-machine (M2M) or Internet of Things (IoT)). Next Generation mobile networks, such as those implementing the 5G mobile telecommunications standard, are expected to enable a higher utilization capacity than current wireless networks, permitting a greater density of wireless users. Next Generation mobile networks are designed to increase data transfer rates, increase spectral efficiency, improve coverage, improve capacity, and reduce latency.

### BRIEF DESCRIPTION OF THE DRAWINGS

FIG. 1 depicts an example network environment in which a process for recovering from Quality of Service (QoS) flow set-up failure may be implemented;

FIG. 2 is a diagram that depicts example components of a network device, as referred to herein;

FIG. 3A-3C are flow diagrams of an example process for recovering from session resource set-up failures for QoS flows in a mobile network; and

FIGS. 4A and 4B illustrate examples of operations, messages, and data flows associated with a process described herein.

### DETAILED DESCRIPTION

The following detailed description refers to the accompanying drawings. The same reference numbers in different drawings may identify the same or similar elements. The following detailed description does not limit the invention.

In Next Generation mobile networks, such as 5G mobile networks, when a User Equipment device (UE) attempts to establish a Packet Data Unit (PDU) session with the mobile network, the Session Management Function (SMF) invokes the Policy Control Function (PCF) to obtain, from the PCF, policy rules to be applied to establishment of the PDU session. The policy rules may include, for example, rules that specify a particular Quality of Service (QoS) level for certain packets of the UE requesting the PDU session. A “PDU session,” as referred to herein includes a logical connection between a UE and a network which can carry one or more QoS flows. Each PDU session can encompass multiple QoS flows, with each QoS flow being tailored to a specific type of service to the UE. As referred to herein, a “QoS flow” includes a logical channel with specific QoS characteristics that guarantee certain service levels for the data transported within the logical channel.

Among the PCF-supplied policy rules may be a default QoS rule that specifies a default QoS flow for the session-requesting UE. A default QoS flow may be classified as non-guaranteed bit rate (non-GBR), meaning that the default QoS flow does not guarantee a fixed data transfer rate. The default QoS flow typically has a lowest priority, and uplink or downlink data flows use this default QoS flow when no higher priority service data flows are matched, by QoS rules of the PCF-supplied policy rules, to the session-requesting UE. The PCF-supplied policy rules may include one or more QoS rules, with each QoS rule including a QoS flow identifier (e.g., a 5G QoS identifier (5QI) in a 5G mobile network), a set of packet filters, and a priority. The set of packet filters in each QoS rule determines which packets should be forwarded to a specific QoS flow identified by the QoS flow ID (QFI).

After receiving the PCF-supplied policy rules, the SMF initiates flow creation for the session-requesting UE by sending a request to the Radio Access Network (RAN) to establish RAN resources for a QoS flow (e.g., a default QoS flow). If the RAN cannot support the request from the SMF, if the RAN currently does not have sufficient RAN resources available, or if a RAN admission control procedure rejects admission of the QoS flow being requested, the SMF, using existing procedures, rejects the QoS flow of the PDU session requested by the UE. Rejection of the QoS flow of the PDU session, using existing procedures, does not give the PCF an opportunity to attempt to recover from the situation. In most cases, QoS flow rejection results in the UE not receiving mobile network service, even after repeated attempts. In large networks, with thousands of RAN nodes, QoS flow rejection leads to a high probability of errors. PDU session rejection is also a significant problem at particular RAN locations that have resource constraints.

Example embodiments described herein modify the existing QoS flow set-up process, with the RAN (e.g., a Next Generation NodeB (gNB) in a 5G mobile network) determining an occurrence of a QoS flow set-up failure and generating one or more error code(s), and an associated description of problem details, that characterize the nature of the QoS flow set-up failure and why the failure has occurred. The RAN returns a failure message to the SMF, along with the one or more error code(s) and the description of problem details. When the SMF receives the error code(s) from the RAN, the SMF notifies the PCF of the error. In response, the PCF obtains and installs new policy rules, selected or generated to recover from the error, and provides one or more of the new policy rules to the SMF for specifying a new QoS flow (e.g., a default QoS flow). The SMF attempts again to establish RAN resources for the new QoS flow determined from the new policy rules, and if the RAN determines that it can support the resource request, has sufficient RAN resources available, and admits the QoS flow using admission control, the RAN successfully sets up the RAN resources for the PDU session. Upon receiving a successful PDU session resource set-up response from the RAN, the SMF returns a PDU session establishment acceptance to the session requesting UE, and the UE may subsequently engage in the PDU session via the RAN. The modification of the QoS flow set-up process, as described herein, enables the mobile network to recover from a number of QoS flow set-up issues, and improves mobile network service to the end users by decreasing service rejections due to QoS flow set-up failures.

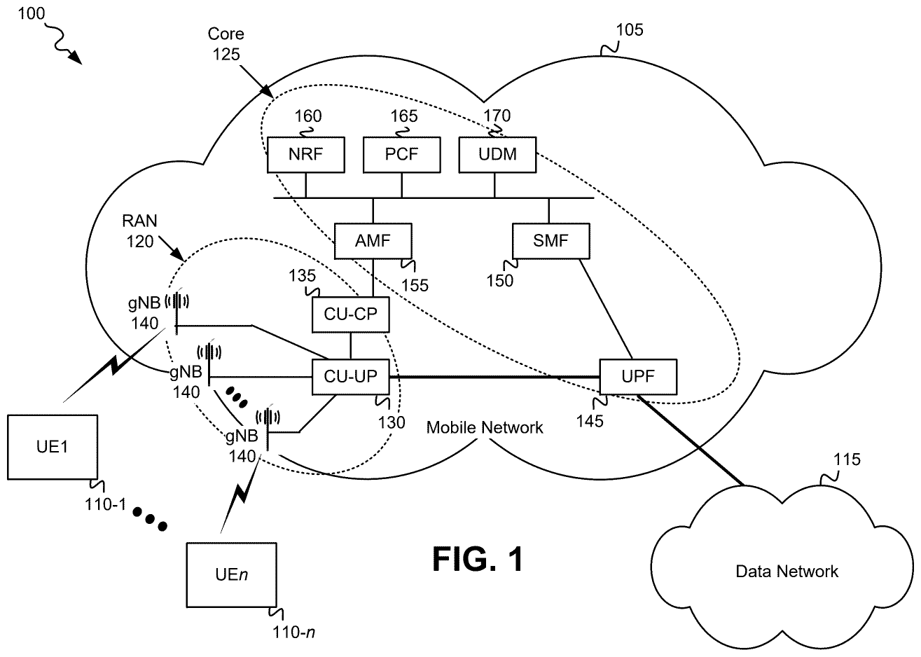

FIG. 1 depicts an example network environment 100 in which a process for recovering from QoS flow set-up failure may be implemented. As shown, network environment 100 may include a mobile network 105, multiple User Equipment devices (UEs) 110-1 through 110-n, and a data network 115.

Mobile network 105 (also referred to herein as “wireless network 105”) may include any type of a Public Land Mobile Network (PLMN). In some implementations, mobile network 105 may include any type of a Next Generation mobile network that may further include evolved network components (e.g., future generation components) relative to a Long-Term Evolution (LTE) network, such as a Fourth Generation (4G) or 4.5G LTE mobile network. For example, mobile network 105 may include a Fifth Generation (5G) mobile network. Mobile network 110 may alternatively include an LTE network (e.g., a 4G network), another type of Next Generation network (e.g., a Sixth Generation (6G) mobile network, a 5G Advanced network), or a hybrid mobile network (e.g., a Next Generation/4G hybrid network).

UEs 110-1 through 110-n (referred to herein individually as “UE 110” or collectively as “UEs 110”) may each include any type of electronic device having a wireless communication capability. Network environment 100 may include any number of UEs 110 (e.g., n>>2). UEs 110 may each include, for example, a laptop, desktop, or tablet computer; a cellular phone (e.g., a “smart” phone); a Voice over Internet Protocol (VoIP) phone; a smart television (TV); an audio speaker (e.g., a “smart” speaker); a video gaming device; a music player (e.g., a digital audio player); a digital camera; a device in a vehicle; a wireless telematics device; an Augmented Reality/Virtual Reality (AR/VR) headset or glasses; or an Internet of Things (IoT) or Machine-to-Machine (M2M) device. A user (not shown) may carry, use, administer, and/or operate each UE 110. Each UE 110 may attempt to establish a Packet Data Unit (PDU) session over mobile network 105, as described further herein.

Data network 115 may include one or more interconnected networks, such as, for example, local area networks (LANs), wide area networks (WANs), metropolitan area networks (MANs), telecommunications networks (e.g., Public Switched Telephone Networks (PSTNs)), cable networks (e.g., optical cable networks), Multi-Access Edge Computing networks (MECs), and/or the Internet. Though data network 115 is shown as a separate network from mobile network 105, data network 115 may, in some implementations, be a portion, or sub-network, of mobile network 105. Data network 115 may include various different types of network nodes (not shown), such as, for example, routers, gateways, switches, web acceleration servers, media storage units, and/or cache memory units.

As further shown in FIG. 1, mobile network 105 may include one or more sub-networks, such as, for example, a RAN 120 and a core network 125. The radio access equipment of RAN 120 may include multiple gNBs 140 (also referred to herein as “base stations”), at least one Control Unit-User Plane function (CU-UP) 130 and at least one Control Unit-Control Plane (CU-CP) function 135. Each gNB 140 shown in FIG. 1 may include one or more Distributed Units (DUs) (not shown) and one or more Remote radio Units (RUs) (not shown). Only a single one of CU-UP 130 and CU-CP 135 is shown in FIG. 1, however, RAN 120 may include multiple CU-UPs 130 and CU-CPs 135. In some implementations, each CU-UP 130 and CU-CP 135 may be associated with one or more clusters of cells within RAN 120. For example, a particular CU-CP 135 may control and manage the operation of gNBs 140 (e.g., the constituent DUs and RUs of the gNBs) residing within one or more clusters of cells, and a corresponding CU-UP 130 may manage and handle user plane traffic that originates from, or is destined to, the gNBs 140 residing within the one or more clusters of cells.

CU-UP 130 may interconnect with one or more DUs of gNBs 140 via fronthaul links or a fronthaul network and may include a logical node that hosts user plane functions, such as, for example, data routing and transport functions. For example, CU-UP 130, among other functions, routes outgoing traffic (e.g., from a UE 110) to a User Plane Function (UPF) 145 and routes incoming traffic to a gNB 140 that serves the traffic's destination UE 110.

Each DU of a gNB 140 includes a logical node that hosts functions associated with the Radio Link Control (RLC) layer, the Medium Access Control (MAC) layer, and the physical layer (PHY). Each DU of a gNB 140 further performs centralized processing and coordination of one or more RUs, handles tasks such as scheduling and overall control of the radio resources, and interfaces with core network functions (NFs) to establish and manage connections with UEs 110 and to facilitate communication between different cells.

RUs of a gNB 140 may be located at certain geographic positions within mobile network 105, and may operate as radio function units that transmit and receive wireless signals (e.g., Radio Frequency (RF) signals) to/from UEs 110. Each of the RUs may include at least one antenna array, transceiver circuitry, and other hardware and software components for enabling the RU to receive data via wireless RF signals from UEs 110, and to transmit wireless RF signals to UEs 110. Each RU may connect to a respective DU (not shown) which, in turn, connects to a CU-UP 130 and a CU-CP 135.

CU-CP 135 includes a logical node that hosts Radio Resource Control (RRC), and other control plane, functions (e.g., Service Data Adaptation Protocol (SDAP), Packet Data Convergence Protocol (PDCP)) for the CU-UP 130 and for the gNBs 140 that it controls. RAN 120 may additionally include other nodes, functions, and/or components not shown in FIG. 1.

Core network 125 includes devices or nodes that host and execute network functions (NFs) that operate the mobile network 105 including, among other NFs, mobile network access management, session management, and policy control NFs. In the example mobile network 105 of FIG. 1, core network 125 is shown as including 5G NFs, such as a UPF 145, a Session Management Function (SMF) 150, an Access and Mobility Management Function (AMF) 155, a Network Repository Function (NRF) 160, a Policy Control Function (PCF) 165, and a Unified Data Management (UDM) function 170. Each of UPF 145, SMF 150, AMF 155, NRF 160, PCF 165, and UDM 170 may be implemented as a Virtual Network Function (VNF) or a Cloud-Native Network Function (CNF) (e.g., at a data center(s)) or as a Physical Network Function (PNF) within mobile network 105.

UPF 145 may act as a router and a gateway between mobile network 105 and data network 115 and may forward session data between data network 115 and RAN 120. Though only a single UPF 145 is shown in FIG. 1, mobile network 105 may include multiple UPFs 145 at various locations in mobile network 105. SMF 150 performs session management and selects and controls UPFs 145 for data transfer. SMF 150 further engages in a process, as described herein, for recovering from QoS flow set-up failure involving a UE-requested PDU session. AMF 155 performs mobility management for the UEs 110.

NRF 160 operates as a centralized repository of information regarding NFs in mobile network 105. NRF 160 enables NFs (e.g., UPF 145, SMF 150, AMF 155, NRF 160, PCF 165, UDM 170) to register and discover each other via an Application Programming Interface (API). NRF 160 maintains an updated repository of information about the NFs available in mobile network 105, along with information about the services provided by each of the NFs. NRF 160 further enables the NFs to obtain updated status information of other NFs in mobile network 105. NRF 160 may, for example, maintain profiles of available NF instances and their supported services, allow NF instances to discover other NF instances in mobile network 105, and allow NF instances to track the status of other NF instances.

PCF 165 may provide policy rules for control plane functions (e.g., for network slicing, roaming, and/or mobility management) and may access user subscription information for policy decisions. PCF 165 may further supply one or more policy rules to SMF 150 for use by SMF 150 in managing and controlling the establishment of PDU sessions, and QoS flows within those PDU sessions. UDM 170 manages data for user access authorization, user registration, and data network profiles. UDM 170 may include, or operate in conjunction with, a User Data Repository (UDR-not shown) which stores user data, such as user/customer/subscriber profile information, user/customer/subscriber authentication information, user/customer-subscribed network slice information, and encryption keys.

The configuration of network components of the example mobile network 105 of FIG. 1 is for illustrative purposes. Other configurations may be implemented. Therefore, network environment 100 may also include additional, fewer, and/or different components, or networks, than shown in FIG. 1. Further, mobile network 105 may include additional, and/or different, nodes, functions, or devices than those shown in FIG. 1. Mobile network 105 is shown in the example of FIG. 1 as including components associated with a 5G mobile network. In other implementations, however, different types of mobile networks or different mobile network components may alternatively, or additionally, be used, such as, for example, 4G, 5G-Advanced, or 6G mobile networks and/or hybrid 4G/5G or 5G/6G mobile networks. Additionally, core network 125 may include other NFs not shown in FIG. 1. Though only a single instance of each of the core network NFs (e.g., UPF 145, SMF 150, AMF 155, NRF 160, PCF 165, UDM 170) is shown in FIG. 1, mobile network 105 may include multiple instances of each of the NFs. When implemented as VNFs or CNFs, each of the NFs described above may be installed in, and executed by, a network device residing in mobile network 105, or in another network (e.g., in an edge or a far edge network, not shown). A single network device may host and execute one or more of the NFs described above, and mobile network 105 may include at least one network device, or may have multiple (e.g., numerous) network devices that each host and execute one or more of the NFs described above.

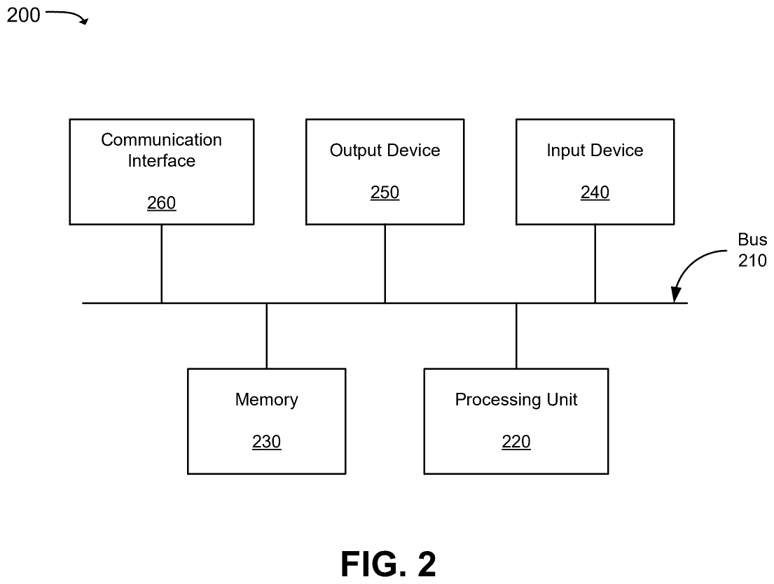

FIG. 2 is a diagram that depicts example components of a network device 200 (referred to herein as a “network device,” or a “device”). UEs 110, the RUs and DUs of each gNB 140, CU-UP 130, and CU-CP 135 may each include components that are the same as, or similar to, those of network device 200 shown in FIG. 2. Furthermore, each of the NFs in mobile network 105 (e.g., UPF 145, SMF 150 AMF 155, NRF 160, PCF 165, and/or UDM 170) may be implemented by a device that includes components that are the same as, or similar to, those of network device 200. Some of the NFs of mobile network 105 may be implemented by a same network device 200 within mobile network 105, while others of the functions may be implemented by one or more separate network devices 200 within mobile network 105.

Network device 200 may include a bus 210, a processing unit 220, a memory 230, an input device 240, an output device 250, and a communication interface 260. Bus 210 may include a path that permits communication among the components of device 200. Processing unit 220 may include one or more hardware processors or microprocessors which may interpret and execute instructions (e.g., software), or hardware-implemented logic. Memory 230 may include one or more memory devices for storing data and instructions. Memory 230 may include a random access memory (RAM) or another type of dynamic storage device that may store information and instructions for execution by processing unit 220, a Read Only Memory (ROM) device or another type of static storage device that may store static information and instructions for use by processing unit 220, and/or a magnetic, optical, or flash memory recording and storage medium. The memory devices of memory 230 may each be referred to herein as a “tangible non-transitory computer-readable medium,” “non-transitory computer-readable medium,” or “non-transitory storage medium.” In some implementations, the processes/methods set forth herein can be implemented as instructions that are stored in memory 230 for execution by processing unit 220.

Input device 240 may include one or more mechanisms that permit an operator to input information into device 200, such as, for example, a keypad or a keyboard, a display with a touch sensitive panel, voice recognition and/or biometric mechanisms, etc. Output device 250 may include one or more mechanisms that output information to the operator, including a display, a speaker, etc. Input device 240 and output device 250 may, in some implementations, be implemented as a user interface (UI) (e.g., a graphical UI (GUI)) that displays UI information and which receives user input via the UI. Communication interface 260 may include a transceiver(s) that enables device 200 to communicate with other devices and/or systems. For example, communication interface 260 may include one or more wired and/or wireless transceivers for communicating via mobile network 105 and/or data network 115. In the case of RUs of gNBs 140 of RAN 120, communication interface 260 may further include one or more antennas or antenna arrays for producing radio frequency (RF) cells or cell sectors.

The configuration of components of network device 200 illustrated in FIG. 2 is for illustrative purposes. Other configurations may be implemented. Therefore, network device 200 may include additional, fewer and/or different components, that may be arranged in a different configuration, than depicted in FIG. 2.

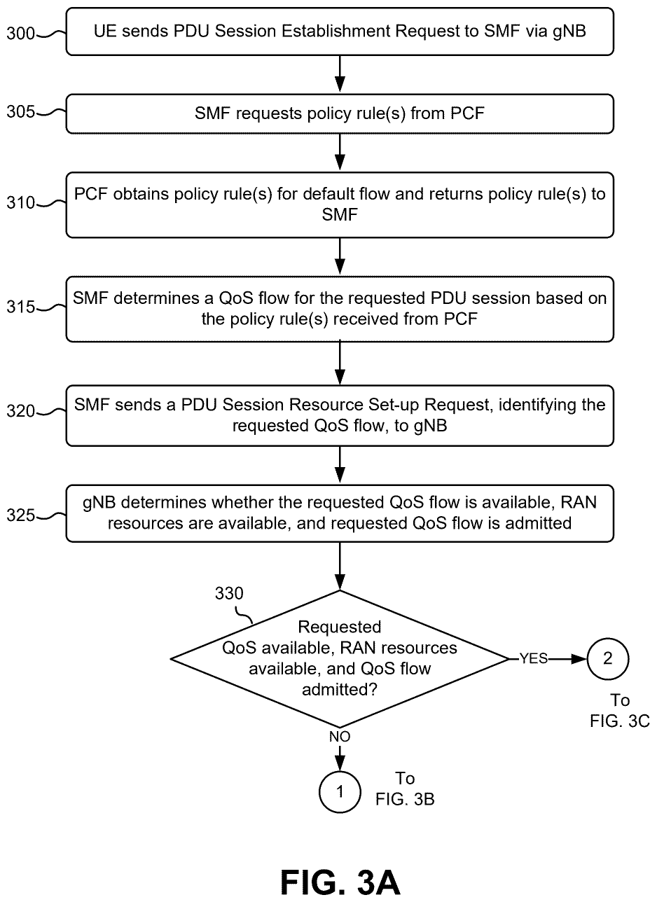

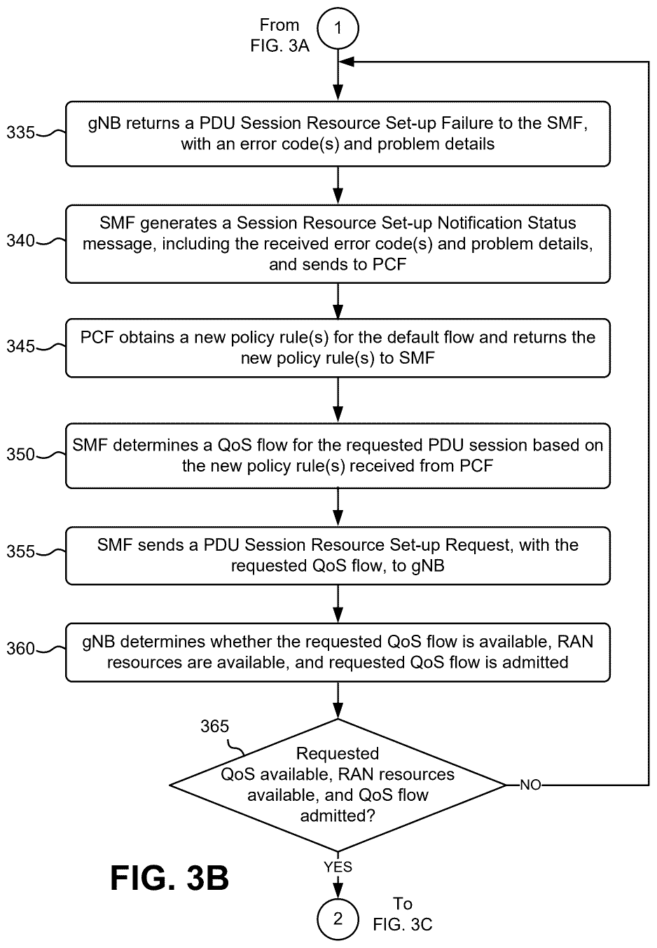

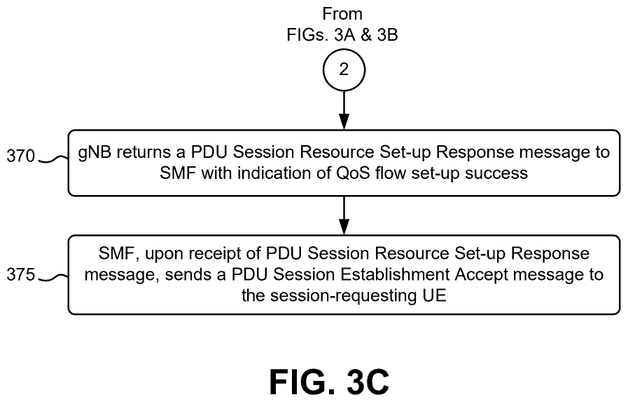

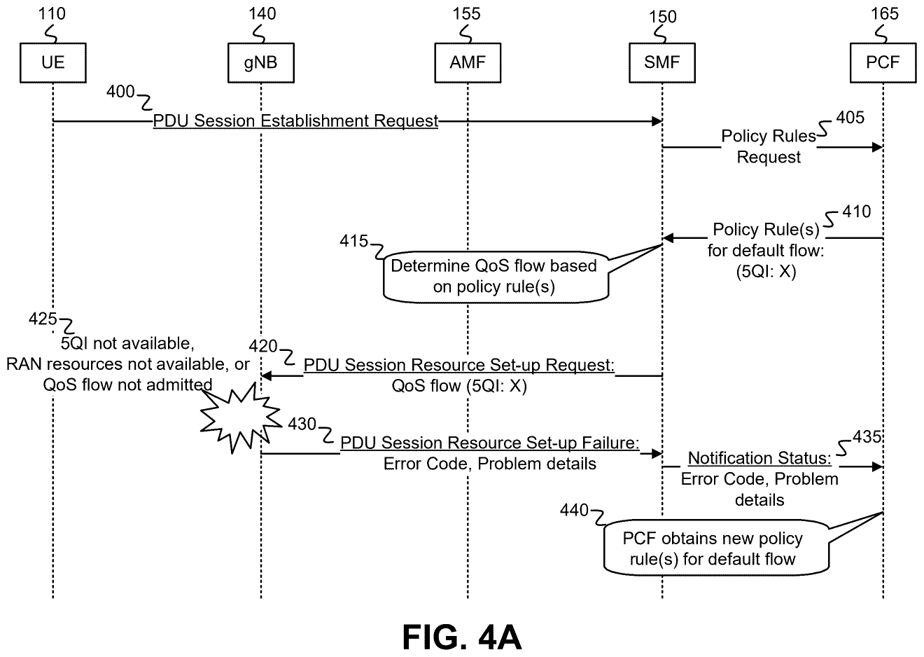

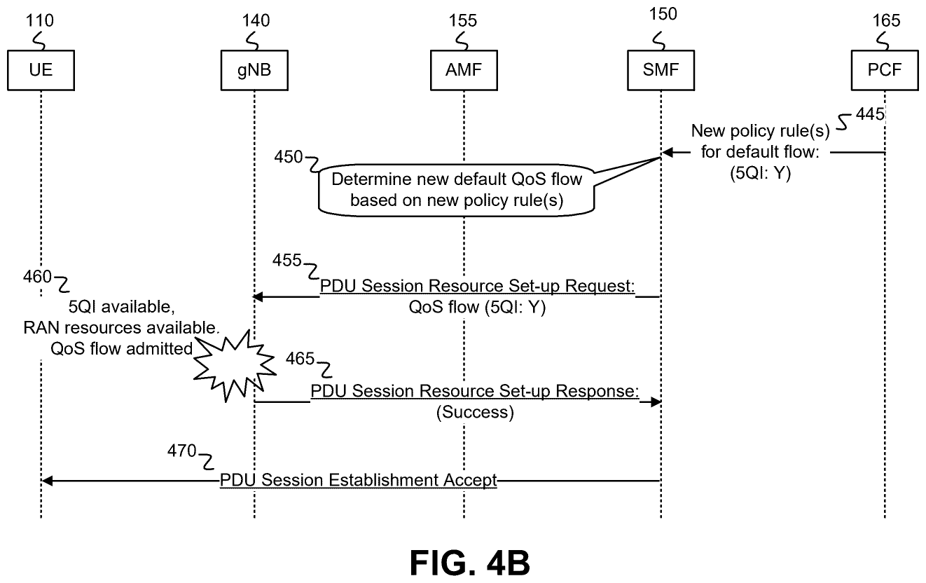

FIG. 3A-3C are flow diagrams of an example process for recovering from session resource set-up failures for QoS flows in a mobile network. The example process of FIGS. 3A-3C may be implemented by, for example, a SMF 150 in cooperation with a PCF 165, a gNB 140, and a UE 110 of mobile network 105. The process of FIG. 3A-3C is described with additional reference to the diagrams of FIGS. 4A and 4B.

The example process includes UE 110 sending a PDU Session Establishment Request for a PDU session to SMF 150 via a gNB 140 (block 300), and, upon receipt of the Request, SMF 150 requests a policy rule(s) from PCF 165 (block 305). To establish a PDU session involving a UE 110, SMF 150 needs to obtain one or more policy rules from PCF 165 that are to be applied to the request for the PDU session. The policy rules may include, possibly among other policy rules, QoS policy rules that, when applied by the SMF 150, determine which UE packets should be allocated to specific QoS flows to ensure the quality of data transmission. Determining which UE packets should be allocated to specific QoS flows may be based on a type of UE packet, a type of the specific application (or an identifier of the specific application) at the UE 110 involved in the PDU session, and/or QoS requirements associated with the UE 110 or the specific application at the UE 110 involved in the PDU session. The example of FIG. 4A depicts UE 110 sending a PDU Session Establishment Request message 400 to SMF 150 via gNB 140, and SMF 150, upon receipt of message 400, sending a policy rules request 405 to PCF 165.

PCF 165 obtains a policy rule(s) for a default flow and returns the policy rule(s) to SMF 150 (block 310). SMF 150 determines a QoS flow for the requested PDU session based on the policy rule(s) received from PCF 165 (block 315), and sends a PDU Session Resource Set-up Request, identifying the requested QoS flow, to gNB 140 (block 320). Each QoS policy rule of the obtained policy rule(s) identify the QoS flow's QoS flow identifier (QFI), identify a priority for the QoS flow, and include a set of packet filters. The set of packet filters determines which packets of the PDU session should be forwarded to a particular QoS flow. Each PDU session may be configured and established with a default QoS rule that is associated with a particular QoS flow. For certain PDU sessions, the default QoS rule may include a set of packet filters that are configured to, for example, allow all uplink packets. The example of FIG. 4A illustrates PCF 165 obtaining a policy rule(s) for a default flow and sending the policy rule(s) 410 to SMF 150. FIG. 4A further shows SMF 150 determining 415 a QoS flow based on the received policy rule(s) and sending a PDU Session Resource Set-up Request message 420 to gNB 140, with message 420 identifying the requested QoS flow.

Upon receipt of the PDU Session Resource Set-up Request, gNB 140 determines whether the requested QoS flow is available, whether RAN resources at the gNB 140 are currently available, and whether the requested QoS flow is admitted by gNB 140 using admission control (block 325). In certain instances, a gNB 140 may not currently support a requested QoS flow. For example, a particular gNB 140 at a location within mobile network 105 may not currently have the capability to support a requested QoS flow having a certain level of QoS. In other circumstances, the gNB 140 may not have sufficient available RAN resources to handle the QoS requirements of the requested QoS flow. To maintain the QoS level for all sessions assigned to a QoS flow, the gNB 140 may have limited resources that may only support a certain number of active sessions on the QoS flow. Additionally, the gNB 140 may apply admission control procedures to the Session Resource Set-up Request based on, for example, congestion levels at the gNB 140. Application of admission control by gNB 140 may result in gNB 140 rejecting the Session Resource Set-up Request.

If the requested QoS flow is available, if the RAN resources at the gNB 140 are currently available, and if the requested QoS flow has been admitted by gNB 140 (YES-block 330), then the example process continues at block 370 (FIG. 3C) below. If the requested QoS flow is not available, or RAN resources at gNB 140 are currently not available, or gNB 140 does not admit the QoS flow using admission control (NO-block 330), then gNB 140 returns a PDU Session Resource Set-up Failure message to the SMF 150, with the message including an error code and a description of problem details (block 335, FIG. 3B). gNB 140 determines one or more reasons why the session resource set-up failed and maps the reason(s) to an error code(s). The error code(s) may subsequently be mapped back by, for example, PCF 165, to the original reason(s) why the session resource set-up failed. gNB 140 further generates a description of details of why the session resource set-up failed that, along with the error code(s), may be used by another node (e.g., PCF 165) to reconstruct and determine the reason(s) for why the session resource set-up failed at the gNB 140. FIG. 4A depicts an example of gNB 140, upon receipt of PDU Session Resource Set-up Request message 420, determining 425 that the requested QoS flow (e.g., 5QI=X) is not available, RAN resources are currently not available, or the requested QoS flow was not admitted by gNB 140. FIG. 4A further shows gNB 140 returning a PDU Session Resource Set-up Failure message 430 to SMF 150 that includes an error code and a description of problem details associated with why the session resource set-up has failed.

Upon receipt of the PDU Session Resource Set-up Failure message, SMF 150 generates a Session Resource Set-up Notification Status message, that includes the received error code and description of problem details, and sends the message to PCF 165 (block 340). In response to receipt of the Status message, PCF 165 obtains and installs new policy rule(s) for the default flow based on the received error code(s) and problem details, and returns the new policy rule(s) to SMF 150 (block 345). PCF 165 may extract the error code(s) and description of problem details from the Notification Status message and may select, or generate, a new policy rule(s) based on the error code(s) and problem details. In some implementations, the new policy rule(s) may be selected/generated to prevent the occurrence of the error, represented by the error code(s) and problem details, that caused the previous session resource set-up request to fail. For example, in some circumstances, PCF 165 may select/generate, based on the error code(s) and problem details, a new policy rule that specifies a new default QoS flow that has a lower level of performance associated with one or more QoS parameters. The one or more QoS parameters may include, but are not limited to, bandwidth, latency, jitter, packet loss, delay, throughput, voice quality metrics, and/or error rate. PCF 165 may, in one implementation, store an ordered set of fallback QoS rules and may select a next fallback QoS in the ordered set. In another implementation, PCF 165 may select or generate a new QoS rule for the requested QoS flow by applying a set of IF-THEN statements to the error code or problem details. For example, IF error_code_A, THEN QoS rule=5QI:X, or IF error_code_B, THEN QoS rule=5GI:Z.

FIG. 4A depicts SMF 150 sending a Notification Status message 435 to PCF 165, where message 435 includes the error code and description of problem details previously received in failure message 430 by SMF 150. FIG. 4A further shows PCF 165, upon receipt of notification status message 435, obtaining 440 a new policy rule(s) for the default flow based on the error code(s) and problem details received in Notification Status message 435. FIG. 4B additionally depicts PCF 165 returning a new policy rule(s) 445 for the default flow to SMF 150.

SMF 150 determines a QoS flow for the requested PDU session based on the new policy rule(s) received from PCF 165 (block 350), and sends a PDU Session Resource Set-up Request, with the requested QoS flow, to gNB 140 (block 355). SMF 150 applies the received policy rule(s) to determine a new QFI for a default QoS flow that is specified by the new policy rule(s). FIG. 4B illustrates SMF 150 determining 450 a QoS flow based on the received new policy rule(s) (e.g., 5QI=Y, where Y is not equal to X), and SMF 150 sending a PDU Session Resource Set-up Request 455 to gNB 140 that identifies the requested QoS flow (e.g., 5QI=Y).

Upon receipt of the PDU Session Resource Set-up Request, gNB 140 again determines whether the requested QoS flow is available, whether RAN resources at the gNB 140 are currently available, and whether the requested QoS flow is admitted by gNB 140 using admission control (block 360). If the requested QoS flow is not available, or RAN resources at gNB 140 are currently not available, or gNB 140 does not admit the QoS flow using admission control (NO—block 365), then the example process returns to block 335 for a repeat of blocks 335-365.

If, however, the requested QoS flow is available, the RAN resources at the gNB 140 are currently available, and the requested QoS flow is admitted by gNB 140 (YES-block 365), then gNB 140 returns a PDU Session Resource Set-up Response message to SMF 150 that includes an indication of QoS flow set-up success (block 370, FIG. 3C). SMF 150, upon receipt of the PDU Session Resource Set-up Response message, sends a PDU Session Establishment Accept message to the session requesting UE 110 to complete the PDU session establishment process (block 375). UE 110 may subsequently engage in the PDU session via the RAN of the mobile network 105. FIG. 4B depicts an example in which gNB 140, upon receipt of the PDU Session Resource Set-up Request message 455, determining 460 that the requested QoS is available (e.g., 5QI=Y), the RAN resources are available, and the QoS flow has been admitted, and gNB 140 then returns a PDU Session Resource Set-up Response message 465 to SMF 150 that indicates successful session resource set-up for the requested QoS flow. As further shown in FIG. 4B, upon receipt of the Response message 465, SMF 150 sends a PDU Session Establishment Accept message 470 to the requesting UE 110, indicating that the requested PDU session has been successfully established.

The example process of FIGS. 3A-3C have been described with respect to recovering from a QoS flow/session set-up failure during PDU session set-up. The technique of obtaining a new policy rule(s) from PCF 165, as a result of a QoS flow request failure, may also be applied to UE service requests, and UE handovers within mobile network 105.

The foregoing description of implementations provides illustration and description, but is not intended to be exhaustive or to limit the invention to the precise form disclosed. Modifications and variations are possible in light of the above teachings or may be acquired from practice of the invention. For example, while series of blocks have been described with respect to FIGS. 3A and 3B, and sequences of operations, messages, and/or data flows with respect to FIGS. 4A and 4B, the order of the blocks and/or the operations, messages, and/or data flows may be varied in other implementations. Moreover, non-dependent blocks may be performed in parallel.

Certain features described above may be implemented as “logic” or a “unit” that performs one or more functions. This logic or unit may include hardware, such as one or more processors, microprocessors, application specific integrated circuits, or field programmable gate arrays, software, or a combination of hardware and software.

Embodiments have been described without reference to the specific software code because the software code can be designed to implement the embodiments based on the description herein and commercially available software design environments and/or languages. For example, various types of programming languages including, for example, a compiled language, an interpreted language, a declarative language, or a procedural language may be implemented.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processing unit 320) of a device. A non-transitory storage medium includes one or more of the storage mediums described in relation to memory 330. The non-transitory computer-readable storage medium may be implemented in a centralized, distributed, or logical division that may include a single physical memory device or multiple physical memory devices spread across one or multiple network devices.

To the extent the aforementioned embodiments collect, store or employ personal information of individuals, such information shall be collected, stored, and used in accordance with all applicable laws concerning protection of personal information. Additionally, the collection, storage and use of such information can be subject to consent of the individual to such activity, for example, through well known “opt-in” or “opt-out” processes as can be appropriate for the situation and type of information. Collection, storage and use of personal information can be in an appropriately secure manner reflective of the type of information, for example, through various encryption and anonymization techniques for particularly sensitive information.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

All structural and functional equivalents to the elements of the various aspects set forth in this disclosure that are known or later come to be known to those of ordinary skill in the art are expressly incorporated herein by reference and are intended to be encompassed by the claims.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
determining, by a Session Management Function (SMF) associated with a mobile network, a first Quality of Service (QoS) flow to be requested for a User Equipment (UE) session based on one or more first policy rules obtained from a Policy Control Function (PCF);
engaging, by the SMF with a Radio Access Network (RAN) associated with the mobile network, in a first session resource set-up process for the first QoS flow for the UE session, wherein the first session resource set-up process results in session resource set-up failure;
determining, by the SMF in response to the session resource set-up failure, a second QoS flow to be requested for the UE session based on one or more second policy rules obtained from the PCF;
engaging, by the SMF with the RAN, in a second session resource set-up process for the second QoS flow for the UE session; and
receiving, by the SMF from the RAN, a session resource set-up success message indicating RAN resources for the second QoS flow for the UE session have been set up.

2. The method of claim 1, further comprising:
requesting, by the SMF from the PCF, policy rules to be applied to the UE session;
receiving, by the SMF from the PCF in response to the request, the one or more first policy rules; and
using, by the SMF, the one or more first policy rules to determine the first QoS flow to be requested for the UE session.

3. The method of claim 1, further comprising:
sending, by the SMF to the PCF, an indication of the session resource set-up failure;
receiving, by the SMF from the PCF in response to the sending, the one or more second policy rules, wherein the one or more second policy rules are different than the one or more first policy rules; and
using, by the SMF, the one or more second policy rules to determine the second QoS flow to be requested for the UE session.

4. The method of claim 1, wherein the first QoS flow comprises a first QoS Identifier (ID) and the second QoS flow comprises a second QoS ID that is different than the first QoS ID.

5. The method of claim 1, wherein engaging in the first session resource set-up process further comprises receiving, by the SMF from the RAN, a Session Resource Set-up failure message that includes an error code and describes details of the session resource set-up failure, the method further comprising:
sending, by the SMF to the PCF, a status message that includes the error code and the details of the session resource set-up failure; and
receiving, by the SMF from the PCF in response to the status message, the one or more second policy rules.

6. The method of claim 1, wherein engaging in the first session resource set-up process further comprises:
sending, by the SMF to the RAN, a first Session Resource Set-up Request message that identifies the first QoS flow; and
receiving, by the SMF from the RAN, a Session Resource Set-up Failure message that includes an error code and describes details of the session resource set-up failure.

7. The method of claim 1, wherein the SMF engages in the first session resource set-up process and the second session resource set-up process with a base station of the RAN.

8. The method of claim 1, further comprising:
causing, by the SMF, establishment of the UE session via the RAN.

9. The method of claim 1, wherein the session resource set-up failure is caused by at least one of the following: the first QoS flow being unavailable, RAN resources currently being unavailable, or the first QoS flow being denied admission to the RAN using admission control.

10. A network device, comprising:
at least one communication interface configured to communicate via a mobile network; and
at least one processor configured to implement a Session Management Function (SMF) for the mobile network to:
determine a first Quality of Service (QoS) flow to be requested for a User Equipment (UE) session based on one or more first policy rules obtained from a Policy Control Function (PCF),
engage, via the at least one communication interface with a Radio Access Network (RAN) associated with the mobile network, in a first session resource set-up process for the first QoS flow for the UE session, wherein the first session resource set-up process results in session resource set-up failure,
determine, in response to the session resource set-up failure, a second QoS flow to be requested for the UE session based on one or more second policy rules obtained from the PCF,
engage, via the at least one communication interface with the RAN, in a second session resource set-up process for the second QoS flow for the UE session; and
receive, via the at least one communication interface from the RAN, a session resource set-up success message indicating RAN resources for the second QoS flow for the UE session have been set up.

11. The network device of claim 10, wherein the at least one processor is further configured to implement the SMF to:
request, via the at least one communication interface from the PCF, policy rules to be applied to the UE session;
receive, via the at least one communication interface from the PCF in response to the request, the one or more first policy rules; and
use the one or more first policy rules to determine the first QoS flow to be requested for the UE session.

12. The network device of claim 10, wherein the at least one communication interface is configured to:
send, to the PCF, an indication of the session resource set-up failure, and
receive, from the PCF in response to the sending, the one or more second policy rules, wherein the one or more second policy rules are different than the one or more first policy rules, and
wherein the at least one processor is further configured to:
use the one or more second policy rules to determine the second QoS flow to be requested for the UE session.

13. The network device of claim 10, wherein the first QoS flow comprises a first QoS Identifier (ID) and the second QoS flow comprises a second QoS ID that is different than the first QoS ID.

14. The network device of claim 10, wherein, when engaging in the first session resource set-up process, the at least one processor is further configured to receive, from the RAN via the at least one communication interface, a Session Resource Set-up failure message that includes an error code and describes details of the session resource set-up failure, and
wherein the at least one communication interface is configured to:
send, to the PCF, a status message that includes the error code and the details of the session resource set-up failure; and
receive, from the PCF in response to the status message, the one or more second policy rules.

15. The network device of claim 10, wherein, when engaging in the first session resource set-up process, the at least one processor is further configured to:
send, to the RAN via the at least one communication interface, a first Session Resource Set-up Request message that identifies the first QoS flow; and
receive, from the RAN via the at least one communication interface, a Session Resource Set-up Failure message that includes an error code and describes details of the session resource set-up failure.

16. The network device of claim 10, wherein the SMF engages in the first session resource set-up process and the second session resource set-up process with a base station of the RAN.

17. The network device of claim 10, wherein the session resource set-up failure is caused by at least one of the following: the first QoS flow being unavailable, RAN resources currently being unavailable, or the first QoS flow being denied admission to the RAN using admission control.

18. A non-transitory storage medium storing instructions executable by a network device, wherein execution of the instructions causes the network device to:
determine a first Quality of Service (QoS) flow to be requested for a User Equipment (UE) session based on one or more first policy rules obtained from a Policy Control Function (PCF) associated with a mobile network;
engage, with a Radio Access Network (RAN) associated with the mobile network, in a first session resource set-up process for the first QoS flow for the UE session, wherein the first session resource set-up process results in session resource set-up failure;
determine, in response to the session resource set-up failure, a second QoS flow to be requested for the UE session based on one or more second policy rules obtained from the PCF;
engage, with the RAN, in a second session resource set-up process for the second QoS flow for the UE session; and
receive, from the RAN, a session resource set-up success message indicating RAN resources for the second QoS flow for the UE session have been set up.

19. The non-transitory storage medium of claim 18, wherein execution of the instructions further causes the network device to:
send, to the PCF, an indication of the session resource set-up failure;
receive, from the PCF in response to the sending, the one or more second policy rules, wherein the one or more second policy rules are different than the one or more first policy rules; and
use the one or more second policy rules to determine the second QoS flow to be requested for the UE session.

20. The non-transitory storage medium of claim 18, wherein execution of the instructions to cause the network device to engage in the first session resource set-up process further causes the network device to receive, from the RAN, a Session Resource Set-up failure message that includes an error code and describes details of the session resource set-up failure, and
wherein execution of the instructions further causes the network device to
send, to the PCF, a status message that includes the error code and the details of the session resource set-up failure; and
receive, from the PCF in response to the status message, the one or more second policy rules.
